(19) United States
(12) Patent Application Publication
(10) Pub. No.: US 2002/0012830 A1
(43) Pub. Date: Jan. 31, 2002

(54) Rechargeable lithium battery

(75) Inventors: Ryuzo Uemura, Kanagawa-ken (JP); Toshihiro Takekawa, Kanagawa-ken (JP); Fumio Munakata, Kanagawa-ken (JP)

Correspondence Address: McDERMOTT, WILL & EMERY, 600 13th Street, N.W., Washington, DC, 20005-3096, US

(73) Assignee: Nissan Motor Co., Ltd.

(21) Appl. No.: 09/917,745

(22) Filed: Jul. 31, 2001

(30) Foreign Application Priority Data
Jul. 31, 2000 (JP) P2000-230492

(51) Int. Cl. H01M 4/48; H01M 4/52; H01M 4/50

(52) U.S. Cl. 429/60; 429/231.95; 429/224; 429/231.1; 429/231.2; 429/231.3; 429/231.5; 429/221

(57) ABSTRACT

A rechargeable lithium battery includes a negative electrode material having a total irreversible capacity of 45% or less of a total capacity of a positive electrode material. By adjusting the irreversible capacity of the negative electrode material in a wide range, a crystalline structure of the positive electrode material during charge-discharge is stably maintained, and cyclic resistance of the rechargeable lithium battery is improved. Moreover, the rechargeable lithium battery having a large capacity and high cyclic resistance at high temperature can be provided by the use of Li deficient type lithium manganese oxide of a layer structure as a positive electrode material.

### BACKGROUND OF THE INVENTION

1. Field of the Invention

The present invention relates to a non-aqueous electrolytic rechargeable lithium battery, more particularly, to a negative electrode material and a positive electrode material for improving cyclic resistance.

2. Description of the Related Art

In recent years, development of an electric vehicle that is of zero emission has been strongly desired as interest in an environmental problem has been increased. As a power source for such an electric vehicle, a rechargeable lithium battery among various secondary batteries has been expected as a secondary battery for an electric vehicle because it has a high charge-discharge voltage and a large charge-discharge capacity.

In the rechargeable lithium battery, a carbon material such as graphite and hard carbon has been mainly employed as a negative electrode material. Also composition of the carbon material in which an irreversible capacity of a negative electrode material is suppressed has been employed so as to be as small as possible in order to improve a charge-discharge capacity of a battery.

Meanwhile, as a positive electrode material, particularly as a positive electrode active material, LiCoO₂ has been employed. However cobalt (Co) is high price and the LiCoO₂ is unstable under an environment where a battery is operated. Lithium manganese complex oxide (LiMn₂O₄) of spinel structure has been mainly employed as a positive electrode active material of the rechargeable lithium battery for an electric vehicle (Japanese Laid-Open Patent Publications No. Hei 11-171550 (published in 1999) and No. Hei 11-73962 (published in 1999)).

Though LiMn₂O₄ of spinel structure is good in cyclic resistance in comparison with the conventional LiCoO₂, the cyclic resistance at high temperature is insufficient, thus causing a problem that the positive material is dissolved in an electrolyte to cause deterioration of the negative electrode in performance. As means for solving this problem, a technique for substituting a part of Mn for a transition metal element or a typical metal element has been tested. However, if Mn is substituted for various elements for the purpose of improving the cyclic resistance at high temperature, distortion is thereby brought into a crystalline structure, leading also to deterioration of the cyclic resistance at room temperature (Japanese Laid-Open Patent Publication No. Hei 11-71115 (published in 1999)). Moreover, if substitution of a large quantity of elements is performed in order to stabilize the crystalline structure for the purpose of improving the cyclic resistance, lowering of a capacity is brought about.

Furthermore, though both of a large capacity and high cyclic resistance are required for the positive electrode active material, the capacity of LiMn₂O₄ of spinel structure is 100 mAh/g, which is lower than the capacity of 140 mAh/g of the conventionally used LiCoO₂ based material.

As described above, LiCoO₂ is unstable though it has a large capacity. Meanwhile, LiMn₂O₄ of spinel structure cannot be said to be sufficient in cyclic resistance and the capacity thereof is small though it is stabler than LiCoO₂. Therefore, desired is development of a novel positive electrode material provided with both of the large capacity and the high cyclic resistance.

### SUMMARY OF THE INVENTION

In order to find a new positive electrode active material of high-capacity lithium complex oxide, research has been carried out based on a study in crystal chemistry (Japanese Patent Publication No. 2870741). In recent years, a LiMnO₂ based material of layer structure, which has a much larger capacity than the conventional LiCoO₂ based material, has been introduced (A. Robert and P. G. Buruce: Nature, vol. 381 (1996) p. 499). The capacity of the layered LiMnO₂ based material is about 270 mAh/g, which is more than twice the capacity of the conventional LiMn₂O₄ of spinel structure.

However, if the layered LiMnO₂ based material having a large capacity is employed as a positive electrode active material of the rechargeable lithium battery, a sufficient charge-discharge characteristic is obtained at, for example, 55° C., however, the capacity at room temperature is reduced to about one-third. Moreover, when charge and discharge are repeated at higher temperature than room temperature in order to ensure the sufficient charge-discharge characteristic, the capacity is gradually reduced, and the sufficient cyclic characteristic is not ensured.

An object of the present invention is to provide a rechargeable lithium battery capable of improving the cyclic resistance, more particularly, to provide a rechargeable lithium battery structure capable of ensuring good cyclic resistance in the case of using a positive electrode material with a large capacity but unstable as described above.

In order to achieve the above object, a rechargeable lithium battery of the present invention is characterized in that a negative electrode material having a total irreversible capacity of 45% or less of a total capacity of a positive electrode is employed.

According to an aspect of the above rechargeable lithium battery of the present invention, the irreversible capacity of the negative electrode material can be adjusted in a wide range, and thus Li deficient quantity from the positive electrode material during charge can be adjusted.

Therefore, as in the aspect of the present invention, if the layered lithium manganese complex oxide with a large capacity but without sufficient structural stability is employed as a positive electrode material, the total irreversible capacity of the negative electrode material is adjusted so as to be larger than that of the conventional one, for example, in a range of about 10% to about 45%, preferably about 20% to about 36%, of the total capacity of the positive electrode material. Thus, the structure of the positive electrode material can be stabilized during charge-discharge, resulting in an increase of the cyclic resistance of the rechargeable lithium battery.

### BRIEF DESCRIPTION OF THE DRAWINGS

FIG. 1 is a perspective view showing the structure example of a rechargeable lithium battery according to an embodiment of the present invention.

FIG. 2 is a graph showing the relationship between carbon contents and irreversible capacities of carbon material employed as a negative electrode of the rechargeable lithium battery.

FIG. 3 is a table showing the composition of a positive electrode, the irreversible capacity of the negative electrode, the number of cycles and the like of each example and a comparison example of the present invention.

FIG. 4 is a perspective view showing the structure of a battery cell fabricated in the examples of the present invention.

### DETAILED DESCRIPTION OF THE EMBODIMENTS

(1. Negative Electrode Material)

In a rechargeable lithium battery, lithium ions partially escape from a positive electrode by initial charge, pass through an electrolyte, and are doped onto a negative electrode. During discharge, the lithium ions doped onto the negative electrode return to the positive electrode. At this time, however, some lithium ions remain still in the negative electrode, and do not contribute to the discharge. A quantity of Li ions remaining in the negative electrode without moving to the positive electrode during the discharge on and after the initial charge is called an irreversible component of the negative electrode, and a capacity thereof is called an irreversible capacity.

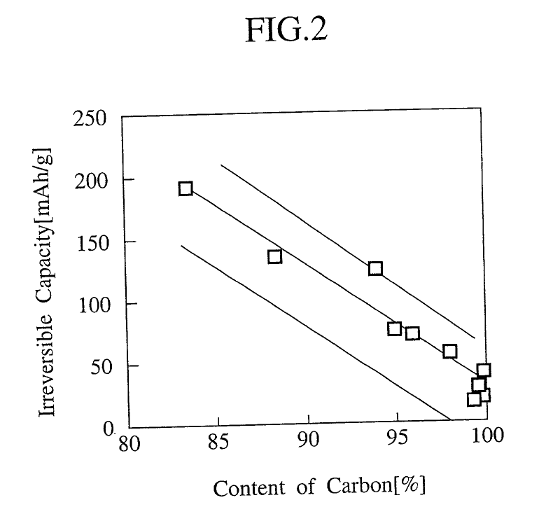

The inventors of the present invention analyzed the irreversible capacity of a carbon material as a negative electrode of the rechargeable lithium battery. As a result, as shown in FIG. 2, it has been found out that the irreversible capacity of the carbon material is inversely proportional to a carbon content in the material, that is, purity of the carbon material, and that, as the carbon content in a negative electrode material is lowered, the irreversible capacity is increased. Specifically, it has been found out that the irreversible capacity of the carbon material can be adjusted by the carbon content in the negative electrode material.

The irreversible capacity of the negative electrode material determines a quantity of Li ions coming in and out of the positive electrode material, that is, a discharge capacity on and after the second charge and discharge of the rechargeable lithium battery. When the irreversible capacity is increased, the discharge capacity is reduced. Therefore, in general, it is preferable to use a negative electrode material with an irreversible capacity as low as possible in order to increase the charge-discharge quantity of a battery. As with reference to the graph of FIG. 2, the irreversible capacity of the negative electrode can be suppressed by the use of a carbon material with the highest possible purity.

Meanwhile, the inventors of the present invention found out that the Li deficient quantity of the positive electrode material, which is caused by the charge-discharge of the battery, can be adjusted by adjusting the irreversible capacity of the negative electrode material in a wider range, and thus the crystalline structure of the positive electrode material can be stabilized.

For example, in the case where the layered lithium manganese complex oxide with a very large capacity but with an unstable crystalline structure and the negative electrode material with a larger irreversible capacity than the conventional one are employed in combination, the Li deficient quantity of the positive electrode material, which is caused by the charge-discharge, can be substantially increased by increasing the irreversible capacity of the negative electrode material more than that of the conventional one. For example, if the negative electrode material with a total irreversible capacity of 10% or more, or 20% or more of a total capacity of the positive electrode material is used, the crystalline structure can be stabilized more, and the cyclic resistance of the rechargeable lithium battery can be improved.

Moreover, in the case where Li deficient type layered lithium manganese complex oxide, which is represented by a general formula Li₁₋ₓMn_{1-y}M_{y}O₂ (where M is a metal element, x>0, y>0), is used as a positive electrode material, the positive electrode already has a stable structure where the Li is deficient before the charge-discharge. Therefore, the cyclic resistance can be further improved.

However, if the irreversible capacity of the negative electrode material is increased too much, the discharge capacity of the rechargeable lithium battery is reduced to a great extent, and a merit of using the layered lithium manganese complex oxide material having high capacity as a positive material is lost. Therefore, the total irreversible capacity of the negative electrode material should be fixed at a range of about 45% or less, preferably about 36% or less, of the total capacity of the positive electrode material.

Specifically, in the rechargeable lithium battery of this embodiment, the total irreversible capacity of the negative electrode material should be fixed at a range of about 10% or more to about 45% or less, preferably about 20% or more to about 36% or less, of the total capacity of the positive electrode material.

The negative electrode material described above is not limited to a carbon material, but various complex oxide or nitride can be also used. When these materials are employed as a negative electrode material, it is recommended to use a negative electrode material of weight obtained by dividing a capacity equivalent to 45% or less of the total capacity of the positive electrode material by an irreversible capacity of the negative electrode material per unit weight.

It should be noted that, in the case where a carbon material is employed as the negative electrode material of the rechargeable lithium battery, the irreversible capacity of the negative electrode material is represented by the following formula with reference to the graph of FIG. 2.

(Irreversible capacity)=−10.1×(carbon content)(%)+(1006 to 1066)

According to the above formula, a carbon content (%) of the carbon negative electrode material with a specified irreversible capacity, that is, carbon purity can be determined.

Furthermore, a capacity balance ratio B/A of the total capacity B of the negative electrode material to the total capacity A of the positive electrode material is preferably fixed at a range of 1 to 1.5. If the capacity balance ratio B/A is below 1, lithium ion holding sites on the negative electrode material become insufficient. As the result, branch-shaped or needle-shaped crystal (dendrite crystal) tends to occur during the charge to cause a short circuit phenomenon between the positive electrode and the negative electrode. If the capacity balance ratio B/A exceeds 1.5, negative electrode sites that do not contribute to the charge-discharge are increased, leading to the wasteful use of materials.

(2. Positive Electrode Material)

A type of the positive electrode material used in combination with the negative electrode material described above is not particularly limited, but Li deficient type lithium manganese complex oxide of a layer structure, which is represented by a general formula Li₁₋ₓMnO₂, Li₁₋ₓMn_{1-y}M_{y}O₂ or Li₁₋ₓMn_{1-y}M_{y}O_{2-δ}, is desirably used. This layered lithium manganese complex oxide is a novel material found by the inventors of the present invention, which has been introduced from a designing concept described below.

In typical NaCl type MO crystal (where M is metal element, O is oxygen), for example, oxide such as NiO has a crystalline structure in which Ni layers and O (oxygen) layers are alternately arrayed in a <111> orientation of the crystal. Moreover, in the conventional LiMO₂ complex oxide of a layer structure (where M is Ni, Co or Mn), the lithium manganese complex oxide of a layer structure taken as an example has a crystalline structure described below. Here, specifically, oxygen planes and metal planes are alternately and repeatedly arrayed in such a manner as: oxygen layer-Mn layer-oxygen layer-Li layer-oxygen layer-Mn layer-oxygen layer, and further, planes (layers) having metal elements thereon are laminated regularly and alternately.

As described above, it is conceived that the NaCl type MO crystal and the layered LiMO₂ complex oxide have structures very similar to each other. When the layered LiMO₂ complex oxide is conceived as one obtained by repeatedly laminating MO crystal blocks with focusing on the regular structure described above, the layered LiMO₂ complex oxide is conceived as one obtained by repeatedly arraying [LiO][MO] blocks, in which MO blocks [MO] and LiO blocks [LiO] are laminated alternately and repeatedly. In this connection, when a crystalline structure of the conventionally known sodium manganese oxide Na_{⅔}MnO₂ is considered by applying the block structure described above, Na_{⅔}MnO₂ can be written as [Na_{⅔}O][MnO]. This suggests that it will be possible to create novel sodium manganese oxide of a layer structure by reducing the Na occupation ratio of the [NaO] blocks in the [NaO][MO] blocks. If this consideration is applied to [LiO][MO] blocks, it is possible to create novel layered lithium manganese oxide by regularly reducing the Li occupation ratio of the [LiO] blocks. It should be noted that the Li sites and the Mn sites originally differ little from each other in terms of the crystal chemistry, and the consideration described above can be also applied to the [MO] blocks similarly.

However, if such as layered manganese oxide is employed as the positive electrode material of the rechargeable lithium battery, a quantity of Mn causing valence variation, which is important in the cyclic charge-discharge, is desirably as much as possible in the crystalline structure. For this reason, M of the [MO] blocks cannot be simply made deficient.

Meanwhile, as in Japanese Patent No. 2870741, when a positive electrode active material represented by a chemical formula LiMn_{1-y}M_{y}O_{2-δ} (where M is a substituted element, y is a rational number of 0 to 0.25) is employed, the capacity of the battery can be increased and the resistance thereof can be improved in comparison with a typical active material of spinel structure. However, particularly in a low temperature range below room temperature, a sufficient operational characteristic cannot be ensured. Specifically, since the distortion and the chemical bond in the crystal cannot be stabilized only by substitution of the Mn sites, the good operation in a low temperature range cannot be ensured. As a result of examination for the effect of making positive ions deficient as described above, the inventors of the present invention obtained a guideline for the material designing described below.

Specifically, making the positive ions deficient at the same time selecting a regular quantity of substituted elements can lessen distortion or strengthen the chemical bond to stabilize the crystal structure. If such a complex oxide designed under the guideline is employed as a positive electrode active material, reaction with an electrolytic solution during the charge-discharge can be suppressed and cyclic stability, durability and stability of the rechargeable lithium battery can be improved.

When the positive electrode active material of complex oxide with manganese layers is considered by applying the above-described block structure in accordance with the designing guideline, the NaCl type complex oxide with Li deficient type layered Li₁₋ₓMnO₂ can be written as [Li₁₋ₓO][MnO]. In this case, the deficient quantity x is regularly varied, the crystalline structure can be stabilized, and thus the cyclic resistance can be improved. For example, as a value of x, there may be ½, ⅓, ⅔, ¼, ⅕, ⅖, ⅙, . . . ⅛, . . . . Moreover, in order to maintain the durability and the stability at high temperature, a block structure of [Li₁₋ₓO][Mn_{1-y}M_{y}O] is enabled, in which the Mn sites are regularly substituted for other metal elements. For example, when x=⅓ and y=½, a block structure [Li_{⅔}O] [Mn_{½}M_{½}O] is enabled, and Li_{⅔}Mn_{½}Ni_{½}O₂ is obtained as a compound possible when M=Ni.

Specifically, the preferable positive electrode material according to this embodiment is the Li deficient type layered lithium manganese complex oxide represented by the general formula Li₁₋ₓMn_{1-y}M_{y}O₂.

Moreover, when the above-described lithium deficient quantity x is small, the quantity of lithium deficient from a congruent composition of the lithium-containing complex oxide is reduced, leading to a tendency of deterioration of the battery during the charge-discharge by Li ion movement, which is not preferable. When the lithium deficient quantity is too much, the quantity of lithium deficient from the congruent composition is increased, leading to a tendency that a sufficient capacity cannot be secured. Therefore, the lithium deficient quantity x is desirably fixed at a rational number range of 0<x<1, preferably 0.03<x≦0.5 or 0.1<x<0.33.

Moreover, the substitution quantity y of the Mn sites for the metal element M is desirably fixed at a rational number range of 0<y<1, preferably 0.03<y≦0.5. If the substitution quantity for the metal element M is small, there occurs a tendency of deterioration of the battery during the discharge by Li ion movement. And on the contrary, when the substitution quantity is increased, there occurs a tendency in which a sufficient capacity cannot be secured.

Furthermore, when the lithium deficient quantity x is represented as a/b, it is desirable that a and b are respectively fixed at a rational number range of 1 to 30, and that a relation of a<b is satisfied. If each of a and b is smaller than 1 or larger than 30, there occurs a tendency in which the effect of Li deficiency is not sufficiently exerted, and thus the cyclic resistance is not ensured. And also when the relation of a<b is not satisfied, the cyclic resistance is not sufficiently secured.

Still further, when the substitution quantity y of the Mn sites for the metal element M is represented as c/d, it is desirable that c and d be respectively set in a rational number range of 1 to 30, and that a relation of c<d be satisfied. The reason is as follows. If each of c and d is smaller than 1 or larger than 30, the effect of substitution for the metal element M is not sufficiently exerted, and thus the cyclic resistance at high temperature is not ensured. And also when the relation of c<d is not satisfied, the cyclic resistance at high temperature is not secured.

Yet further, composition variation ranges of the lithium deficient quantity x and of the substitution quantity y of the Mn sites for the metal element M are desirably set within ±5%. The cyclic resistance is not sufficiently ensured if the variation ranges exceed ±5%.

And, the quantity of oxygen deficiency δ is desirably set as: δ≦0.2. If δ is larger than 0.2, there occurs a tendency in which the crystalline structure becomes unstable and deteriorated.

It should be noted that the substitution metal element M is desirably at least one or more of metals selected from the transition metal elements and the typical metal elements excluding Mn. For example, as the substitution metal element M, at least one selected from Co, Ni, Fe, Al, Ga, In, V, Nb, Ta, Ti, Zr and Ce or the one including at least Cr is desirable.

(3. Structure and Manufacturing Method of the Rechargeable Lithium Battery)

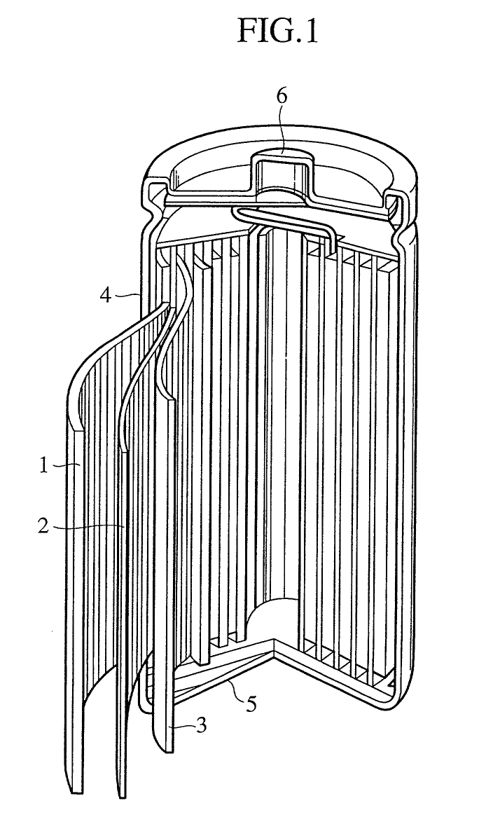

FIG. 1 shows a representative structure example of the rechargeable lithium battery according to the embodiment of the present invention. As shown in FIG. 1, a device, in which a positive electrode 1 obtained by coating a positive electrode active material on both surfaces of a metal foil collector, a negative electrode 3 similarly obtained by coating a negative electrode active material on both surfaces of a metal foil collector, and separator 3 interposed between the both electrodes are wound in a roll fashion, is accommodated in a sealing can 4, and an electrolyte (electrolytic solution) is filled therein.

(1) Negative Electrode Material

As a negative electrode material of the rechargeable lithium battery of this embodiment, complex oxide, nitride or the like can be employed. However, a carbon material for use in a typical non-aqueous electrolytic secondary battery is preferably employed. Such a carbon material can include, for example, coke, natural graphite, artificial graphite and hard carbon. As described above, the irreversible capacity of the carbon material can be basically controlled by the carbon content in the material. Moreover, since the irreversible capacity characteristic is varied in each carbon material, the carbon materials can be mixed so as to obtain a predetermined total irreversible capacity. Furthermore, the predetermined irreversible capacity can be also obtained by adjusting weight of the carbon material.

(2) Positive Electrode Material

As described above, the positive electrode material of the rechargeable lithium battery of this embodiment is not particularly limited. However, the Li deficient type lithium manganese complex oxide of a layer structure is preferably used. In order to prepare this Li deficient type layered lithium manganese complex oxide, the following process is used.

First, a manganese compound, a lithium compound and a metal compound are mixed. As the manganese compound, electrolytic manganese dioxide, chemosynthetic manganese dioxide, dimanganese trioxide, γ-MnOOH, manganese carbonate, manganese nitrate, manganese acetate or the like can be employed. Moreover, an average diameter of manganese compound powder is appropriately fixed at a range of 0.1 to 100 μm, preferably 20 μm or less. This is because, in the case where an average size of the manganese compound is large, reaction of the manganese compound and the lithium compound becomes significantly slow, and it becomes difficult to obtain a uniform product.

As the lithium compound, lithium carbonate, lithium hydroxide, lithium nitrate, lithium oxide, lithium acetate or the like can be employed. Lithium carbonate or lithium hydroxide is preferably employed, and an average diameter thereof is desirably 30 μm or less.

As the metal compound, nitrate, acetate, citrate, chloride, hydroxide, oxide or the like of transition metal can be employed.

A mixing method of the above-described materials includes a dry or wet mixing method of the manganese compound, the lithium compound and the transition metal compound, a dry or wet mixing method of the lithium compound and manganese-transition metal complex oxide obtained by synthesizing the manganese compound and the transition metal compound, a dry or wet mixing method of LiMnO₂ and the transition metal compound, a method of obtaining a product from a solution of the lithium compound, the manganese compound and the transition metal compound by a coprecipitation method by the use of citric acid, ammonium bicarbonate and the like. The most suitable method for obtaining a homogeneous product is the one, in which a mixed solution obtained by completely dissolving the manganese compound and the transition metal compound into ion-exchange water in advance is dropped into a lithium hydroxide solution to obtain a coprecipitation product, and then the coprecipitation product and the lithium compound of a quantity short for the target composition ratio are mixed by dry or wet mixing. The coprecipitation product obtained by the above-described method may be employed by adding the lithium compound of a quantity short for the target composition ratio thereto, after it is made to be a manganese-transition complex metal compound by baking.

Next, the mixture thus obtained is baked. The baking must be performed in an atmosphere with a low oxygen density. Preferably, the baking is performed in an atmosphere of gas containing no oxygen such as nitrogen, argon and carbon dioxide. And in this case, a partial pressure of oxygen is set equal to 1000 ppm or less, preferably 100 ppm or less.

Baking temperature is fixed equal to 1100° C. or less, preferably 950° C. or less. This is because the product is decomposed if the temperature exceeds 1100° C. Baking time is fixed at a range of 1 to 48 hours, preferably 5 to 24 hours. As the baking method, one-step baking may be employed. Also a multi-step baking performed by varying a baking temperature may be performed according to needs.

It should be noted that the partial pressure of oxygen in the baking atmosphere can be efficiently reduced by adding a carbon-containing compound, preferably carbon powder such as carbon black and acetylene black, or an organic material such as citric acid to the mixture of the lithium compound and the manganese compound. A content of such additive is fixed at a range of 0.05 to 10%, preferably 0.1 to 2%. If the quantity of additive is small, an effect thereof is small. On the contrary, if the quantity is large, a by-product tends to be generated, and therefore, purity of the target product is reduced due to the residual carbon-containing compound added.

(3) Non-aqueous Electrolyte

As a non-aqueous electrolyte (non-aqueous electrolytic solution), the one obtained by dissolving a lithium salt as a supporting electrolyte into a non-aqueous organic solvent. As a lithium salt, LiClO₄, LiAsF₆, LiPF₆, LiBF₄, LiCF₃SO₃, Li(CF₃SO₂)₂N or the like can be employed.

The organic solvent is not particularly limited. However, it includes a carbonate group, a lactone group, an ether group and the like. For example, a solvent such as ethylene carbonate, propylene carbonate, diethyl carbonate, dimethyl carbonate, methyl ethyl carbonate, 1,2-dimethoxy ethane, 1-2-diethoxy ethane, tetrahydrofuran, 1,3-dioxolane, γ-buthyrolactone can be employed singly or in mixture of two or more. Concentration of the electrolyte dissolved in such a solvent can be fixed at a range of 0.5 to 2.0 mol/l.

Besides the above solvent, a solid or viscous body having a lithium salt dispersed evenly in a high molecular matrix or the one obtained by immersing a non-aqueous solvent in such a solid or viscous body can be also used. As a high molecular matrix, for example, polyethylene oxide, polypropylene oxide, polyacrylonitrile, polyvinylidene fluoride or the like can be used.

Moreover, for the purpose of preventing a short circuit between the positive electrode and the negative electrode, a separator can be provided. As a separator, a porous sheet, a nonwoven fabric or the like made of a material such as polyethylene, polypropylene and cellulose is employed.

### EXAMPLES

Examples of the present invention and a comparative example will be described.

The positive electrode materials of the rechargeable lithium batteries in examples 1 to 9 were prepared by the use of a coprecipitation method described below. The positive electrode materials in examples 10 to 17 were prepared by the use of a solid-phase mixing method. Moreover, sealed-type non-aqueous solvent battery cells were assembled with the positive electrode materials obtained in the examples and the comparison example together with the carbon negative electrode materials and the electrolytes. And, the performances of the batteries were evaluated.

[Synthesis of Positive Electrode Material by Coprecipitation Method]

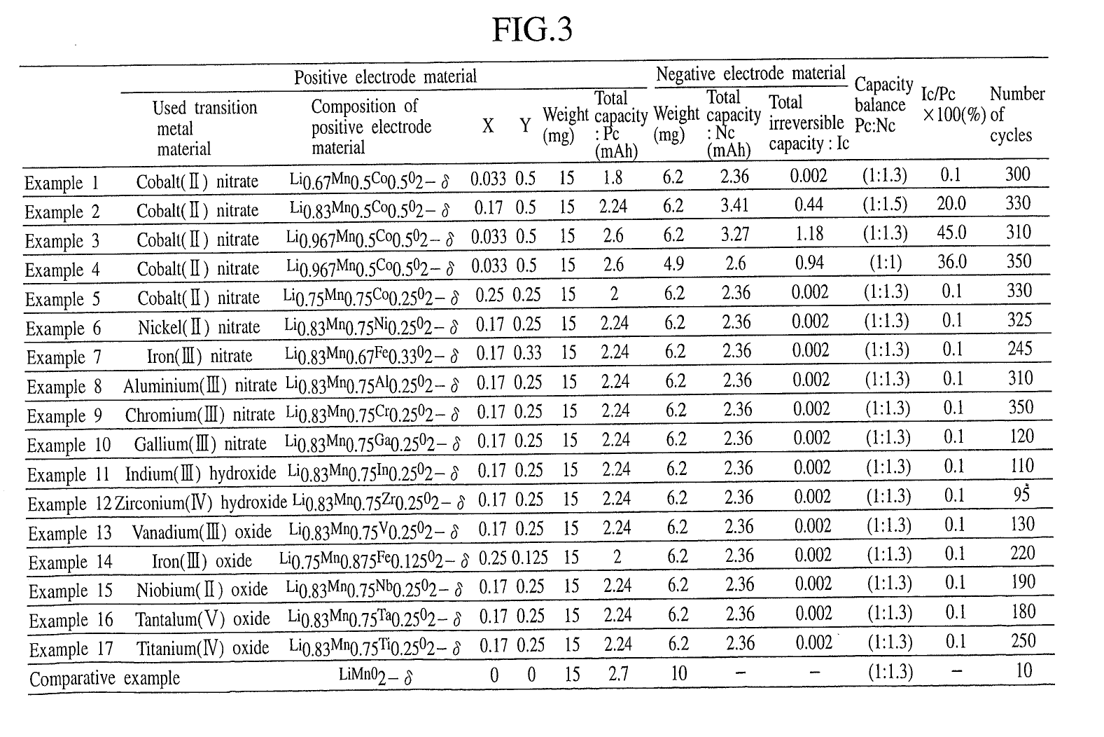

A mixed solution with a specified mol ratio between Mn and the transition metal M was prepared by the use of manganese nitrate and a compound of the transition metal M as shown in Table 1 of FIG. 3. While maintaining pH of an agitated 10% solution of lithium hydroxide at 9 or higher, the above-described mixed solution was dropped thereinto for 30 minutes or more to obtain brown slurry. Next, the slurry was filtered, and then cleaned by the use of ion-exchange water. The brown solid body thus obtained was dried and ground to 20 μm or smaller in average particle diameter. To the product thus obtained, lithium hydroxide-hydrate was added so that a stoichiometrical ratio of (Mn+M) and Li can be 1:1, and was mixed in a mortar. Thereafter, baking was performed in an argon atmospheric current at 900° C. for 24 hours. Thus, the respective positive electrode materials of examples 1 to 9 were obtained. Table 1 of FIG. 3 shows chemical compositions of the lithium manganese complex oxides thus obtained.

[Synthesis of Positive Electrode Material by Solid-phase Mixing Method]

Lithium hydroxide-hydrate powder, dimanganese trioxide powder and each compound of the transition metal M shown in Table 1 were added with specified mol ratios, and were mixed in the mortar. Then, each mixture thus obtained was heated in an argon atmosphere at 900° C. for 24 hours. Thus, the respective positive electrode materials of examples 10 to 17 were obtained. Table 1 of FIG. 3 shows chemical compositions of the lithium manganese complex oxides thus obtained.

[Fabrication of Battery]

The positive electrode materials obtained by the above-described methods were ground, respectively. The powder thus obtained, acetylene black as a conducting material and PTFE powder as bond were mixed in a mass ratio of 80:16:4. The mixture thus obtained was pressurized with 2 t/cm² to form a disk with a diameter of 12 mm. The disk thus obtained was heated at 150° C. for 16 hours, thus making the positive electrode.

For the purpose of making the negative electrode, KF polymer made by Kureha Chemical Industry, Co., Ltd as a binder was added to each carbon material so that a mass ratio thereof could be 10%. The mixture thus obtained was subjected to viscosity adjustment by N-methyl-2-pyrolidone, and was dispersed by a homogenizer at the number of revolutions of 3000 rpm for 30 minutes. After vacuum degassing, the mixture was coated on copper foil by a doctor blade so as to have a film thickness of 100 μm, and was dried at 150° C. for 10 minutes. Thus dried one was died to a diameter of 15 mm. Thus, the negative electrode was made.

Moreover, by the use of hard carbon made by Mitsubishi Gas Chemical Company, Inc., negative electrodes were made as described above. Here, the charge-discharge was performed therefor at 0.5 mA for 40 hours with a lithium metal plate as an opposite electrode. Then, decomposition was performed therefor in an argon gas atmosphere. Thus, carbon negative electrodes, each of which has a total irreversible capacity of 0.002 mAh, were made.

As an electrolyte, a solution obtained by dissolving LiPF₆ with concentration of 1 mol/l to a mixed solvent of ethylene carbonate and dimethyl carbonate with a volume ratio of 2:1 was used. As a separator, a polypropylene film was employed.

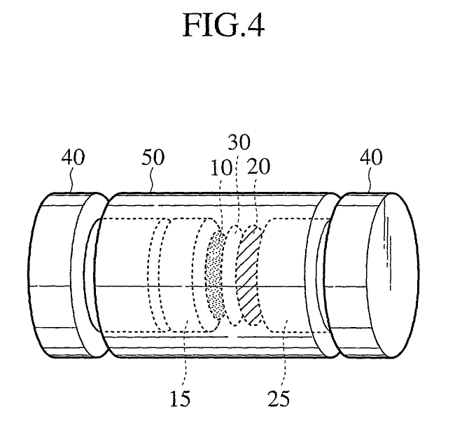

As shown in FIG. 4, SUS thin plates were used as current collectors 15 and 25 of the positive and negative electrodes. Positive electrode and negative electrode bodies 10 and 20 were opposed to each other to constitute a device in a state where leads were individually drawn therefrom and a separator 30 was interposed therebetween. While pressing by a spring, the device was sandwiched by two PTFE plates 40. Moreover, a side of the device was covered with a PTFE plate 50 to be sealed, and thus the sealed-type non-aqueous solvent battery cell was made. Moreover, the cell was made under an argon atmosphere.

[Evaluation]

The charge-discharge was repeatedly performed at a constant current of 0.5 mA/cm² and a voltage ranging from 4.3 V to 2.0 V at an atmospheric temperature of 60° C. by the use of the made sealed type non-aqueous solvent battery cell. The number of cycles taken to a point where the discharge capacity becomes less than 90% of the initial discharge capacity was obtained. Thus, the resistance was evaluated. A result thereof is shown in Table 1 together with the other values.

Hereinbelow, concrete description will be made for components of the positive electrode and negative electrode materials and the like in the respective examples.

### Example 1

Li_{0.67}Mn_{0.5}Co_{0.5}O_{2-δ} according to example 1 can be written as [Li_{⅔}O][Mn_{½}Co_{½}O] by the use of block structure description without consideration of oxygen deficiency. This is an example where x=⅓ and y=½, and the transition metal M is Co in a general block structural formula [Li₁₋ₓO][Mn_{1-y}M_{y}O]. With using this material as a positive electrode and carbon having a total irreversible capacity of 0.002 mAh as a negative electrode, a rechargeable lithium battery was fabricated.

### Example 2

Li_{0.83}Mn_{0.05}Co_{0 5}O_{2-δ} according to example 2 can be written as [Li_{⅚}O][Mn_{½}Co_{½}O] by the use of block structure description without consideration of oxygen deficiency. This is an example where x=⅙ and y=½, and the transition metal M is Co in the general block structural formula [Li₁₋ₓO][Mn_{1-y}M_{y}O]. With using this material as a positive electrode and hard carbon made by Kureha Chemical Industry, Co., Ltd whose carbon content is 95.5% as a negative electrode, a rechargeable lithium battery provided with the negative electrode having a total irreversible capacity of 0.44 mAh was fabricated.

### Example 3

Li_{0.967}Mn_{0.5}Co_{0.5}O_{2-δ} according to example 3 can be written as [Li_{29/300}][Mn_{½}Co_{½}O] by the use of block structure description without consideration of oxygen deficiency. This is an example where x=1/30 and y=½, and the transition metal M is Co in the general block structural formula [Li₁₋ₓO][Mn_{1-y}M_{y}O]. With employing this material as a positive electrode and Binchotan hard carbon with a carbon content of 83.5% as a negative electrode, a rechargeable lithium battery provided with the negative electrode having a total irreversible capacity of 1.18 mAh was fabricated.

### Example 4

With employing the same material as that in example 3 as a positive electrode and Binchotan hard carbon with a carbon content of 83.5% as a negative electrode, a rechargeable lithium battery provided with the negative electrode having a total irreversible capacity of 0.94 mAh was fabricated.

### Example 5

Li_{0.75}Mn_{0.75}Co_{0.25}O_{2-δ} according to example 5 can be written as [Li_{¾}O][Mn_{¾}Co_{¼}O] by the use of block structure description without consideration of oxygen deficiency. This is an example where x=¼ and y=¼, and the transition metal M is Co in the general block structural formula [Li₁₋ₓO][Mn_{1-y}M_{y}O]. With using this material as a positive electrode and carbon having a total irreversible capacity of 0.002 mAh as a negative electrode, a rechargeable lithium battery was fabricated.

### Example 6

Li_{0.83}Mn_{0.75}Ni_{0.25}O_{2-δ} according to example 6 can be written as [Li_{⅚}O][Mn_{¾}Ni_{¼}O] by the use of block structure description without consideration of oxygen deficiency. This is an example where x=⅙ and y=¼, and the transition metal M is Ni in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 7

Li_{0.83}Mn_{0.67}Fe_{0.33}O_{2-δ} according to example 7 can be written as [Li_{⅚}O][Mn_{⅔}Fe_{⅓}O] by the use of block structure description without consideration of oxygen deficiency. This is an example where x=⅙ and y=⅓, and the transition metal M is Fe in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 8

Li_{0.83}Mn_{0.75}Al_{0.25}O_{2-δ} according to example 8 can be written as [Li_{⅚}O][Mn_{¾}Al_{¼}O] by the use of block structure description without consideration of oxygen deficiency. This is an example where x=⅙ and y=¼, and the transition metal M is Al in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 9

Li_{0.83}Mn_{0.75}Cr_{0.25}O_{2-δ} according to example 9 can be written as [Li_{⅚}O][Mn_{¾}Cr_{¼}O] by the use of block structure description without consideration of oxygen deficiency. This is an example where x=⅙ and y=¼, and the transition metal M is Cr in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 10

Li_{0.83}Mn_{0.75}Ga_{0.25}O_{2-δ} according to example 10 can be written as [Li_{⅚}O][Mn_{¾}Ga_{¼}O] by the use of block structure description without consideration of oxygen deficiency. This is an example where x=⅙ and y=¼, and the transition metal M is Ga in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 11

Li_{0.83}Mn_{0.75}In_{0.25}O_{2-δ} according to example 11 can be written as [Li_{⅚}O][Mn_{¾}In_{¼}O] by the use of block structure description without consideration of oxygen deficiency. This is an example where x=⅙ and y=¼, and the transition metal M is In in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 12

Li_{0.83}Mn_{0.75}Zn_{0.25}O_{2-δ} according to example 12 can be written as [Li_{⅚}O][Mn_{¾}Zn_{¼}O] by the use of block structure description without consideration of oxygen deficiency. This is an example where x=⅙ and y=¼, and the transition metal M is Zn in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 13

Li_{0.83}Mn_{0.75}V_{0.25}O_{2-δ} according to example 13 can be written as [Li_{⅚}O][Mn_{¾}V_{¼}O] by the use of block structure description without consideration of oxygen deficiency. This is an example where x=⅙ and y=¼, and the transition metal M is V in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 14

Li_{0.75}Mn_{0.875}Fe_{0.125}O_{2-δ} according to example 14 can be written as [Li_{¾}O][Mn_{⅞}Fe_{⅛}O] by the use of block structure description without consideration of oxygen deficiency. This is an example where x=¼ and y=⅛, and the transition metal M is Fe in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 15

Li_{0.83}Mn_{0.75}Nb_{0.25}O_{2-δ} according to example 15 can be written as [Li_{⅚}O][Mn_{¾}Nb_{¼}O] by the use of block structure description without consideration of oxygen deficiency. This is an example where x=⅙ and y=¼, and the transition metal M is Nb in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 16

Li_{0.83}Mn_{0.75}Ta_{0.25}O_{2-δ} according to example 16 can be written as [Li_{⅚}O][Mn_{¾}Ta_{¼}O] by the use of block structure description without consideration of oxygen deficiency. This is an example where x=⅙ and y=¼, and the transition metal M is Ta in the general block structural formula [Li₁₋ₓO][Mn_{1-y}M_{y}O]. With employing this material as a positive electrode and carbon having a total irreversible capacity of 0.002 mAh as a negative electrode, a rechargeable lithium battery was fabricated.

### Example 17

Li_{0.83}Mn_{0.75}Ti_{0.25}O_{2-δ} according to example 17 can be written as [Li_{⅚}O][Mn_{¾}Ti_{¼}O] by the use of block structure description without consideration of oxygen deficiency. This is an example where x=⅙ and y=¼, and the transition metal M is Ti in the general block structural formula [Li₁₋ₓO][Mn_{1-y}M_{y}O]. With using this material as a positive electrode and carbon having a total irreversible capacity of 0.002 mAh as a negative electrode, a rechargeable lithium battery was fabricated.

### COMPARATIVE EXAMPLE

In a comparative example 1, a lithium metal plate in which an irreversible capacity was zero was employed as a negative electrode. And as a positive electrode material, lithium manganese complex oxide without lithium deficiency was employed. Specifically, by the use of block structure description without consideration of oxygen deficiency, this material can be written as [LiO][MnO], and this is an example where x=0 and y=0 in the general block structural formula [Li₁₋ₓO][Mn_{1-y}M_{y}O].

(Results)

As apparent from the results shown in a Table of FIG. 3, while the comparative example employing the lithium metal plate without a total irreversible capacity as a negative electrode exhibits only about 10 cycles of resistance, it was found out that the respective examples of the present invention exhibit the cyclic resistance of roughly 10 to 35 times that of the above-described comparison example. Here in each example, a carbon material with a total irreversible capacity equivalent to 0.1 to 45% of the total capacity of the positive electrode material was employed as a negative electrode material, and as a positive electrode material, lithium-deficient manganese complex oxide of a layer structure was employed, whose general formula is represented as Li₁₋ₓMn_{1-y}M_{y}O_{2-δ}, where each of x and y is a rational number larger than 0.03 and equal to 0.5 or smaller, and M indicates the one selected from Co, Ni, Fe, Al, Cr, Ga, In, Zr, V, Nb, Ta and Ti.

As described above, the present invention can provide a non-aqueous electrolytic rechargeable lithium battery, which has the capacity higher than the conventional battery employing lithium manganese complex oxide of spinel structure, and exhibits more excellent cyclic resistance at high temperature than that using lithium manganese complex oxide of a layer structure. Particularly, the present invention can provide a compact and long-life rechargeable lithium battery for an electric vehicle (EV) or a hybrid electric vehicle (HEV).

The entire contents of Japanese Patent Applications P2000-230492 (filed on Jul. 31, 2000), P2000-058093 (filed on Mar. 3, 2000), P2000-058097 (filed on Mar. 3, 2000) and P2000-058104 (filed on Mar. 3, 2000) are incorporated herein by reference.

Although the inventions have been described above by reference to certain embodiments of the inventions, the inventions are not limited to the embodiments described above. Modifications and variations of the embodiments described above will occur to those skilled in the art, in light of the above teachings.

The scope of the inventions is defined with reference to the following claims.

What is claimed is:

1. A rechargeable lithium battery, comprising:
a positive electrode material;
a negative electrode material having a total irreversible capacity of about 45% or less of a total capacity of the positive electrode material; and
a non-aqueous electrolyte interposed between the positive electrode material and the negative electrode material.

2. The rechargeable lithium battery according to claim 1, wherein the total irreversible capacity of the negative electrode material is set in a range of about 10% or more to about 45% or less of the total capacity of the positive electrode material.

3. The rechargeable lithium battery according to claim 1, wherein the total irreversible capacity of the negative electrode material is set in a range of about 20% or more to about 36% or less of the total capacity of the positive electrode material.

4. The rechargeable lithium battery according to claim 1, wherein the negative electrode material includes any one of complex oxide, nitride and a carbon material.

5. The rechargeable lithium battery according to claim 1, wherein the negative electrode material has weight obtained by dividing a capacity of about 45% or less of the total capacity of the positive electrode material by an irreversible capacity of the negative electrode material per unit weight.

6. The rechargeable lithium battery according to claim 1, wherein the negative electrode material is a carbon material having an irreversible capacity per unit weight for a carbon content, the irreversible capacity being represented by the following formula:
(Irreversible capacity)=−10.1×(carbon content (%))+(1006 to 1066)

7. The rechargeable lithium battery according to claim 1, wherein a ratio (B/A) of the total capacity B of the negative electrode material to the total capacity A of the positive electrode material is in a range of about 1 to about 1.5.

8. The rechargeable lithium battery according to claim 1, wherein the positive electrode material is lithium manganese complex oxide of a layered crystalline structure represented by a general formula Li₁₋ₓMn_{1-y}M_{y}O₂, where x is a lithium deficient quantity and established as x≧0, and y is a substitution quantity of Mn sites for a metal element M and established as: y≧0.

9. The rechargeable lithium battery according to claim 8, wherein the positive electrode material comprises Li partially deficient from a congruent composition and Mn as a main component partially substituted for other metal elements, the Li deficient quantity x being established as: x>0, and the substitution quantity y of the Mn sites for the metal element M being established as: y>0.

10. The rechargeable lithium battery according to claim 9, wherein the positive electrode material has a crystalline structure with the controlled regularly Li deficient quantity and substitution quantity of the Mn sites, the Li deficient quantity x being a rational number set in a range of 0<x<1, and the substitution quantity y of the Mn sites for the metal element M being a rational number set in a range of 0<y<1.

11. The rechargeable lithium battery according to claim 9, wherein the positive electrode material has a crystalline structure with the controlled regularly Li deficient quantity and the substitution quantity of the Mn sites to satisfy:
that each of a and b is a natural number set in a range of 1 to 30 and established as: a<b when the Li deficient quantity x is represented as: a/b, and that each of c and d is a natural number set in a range of 1 to 30 and established as: c<d when the substitution quantity y of the Mn sites for the metal element M is represented as: c/d.

12. The rechargeable lithium battery according to claim 11, wherein the positive electrode material has composition variation ranges of the Li deficient quantity x and of the substitution quantity y of the Mn sites for the metal element M set within ±5%.

13. The rechargeable lithium battery according to claim 1, wherein the positive electrode material is represented by a general formula Li₁₋ₓMn_{1-y}M_{y}O_{2-δ}, and
the positive electrode material has a crystalline structure with the controlled regularly Li deficient quantity and the substitution quantity of the M to satisfy:
that each of a and b is a natural number set in a range of 1 to 30 and established as a<b, and the composition variation range of x is set within ±5% when the Li deficient quantity x is represented as: a/b;
that each of c and d is a natural number set in a range of 1 to 30 and established as c<d, and the composition variation range of y is set within ±5% when the substitution quantity y of the Mn sites for the metal element M is represented as: c/d; and
that an oxygen deficient quantity δ is established as: δ≦0.2.

14. The rechargeable lithium battery according to claim 13, wherein the positive electrode material has the substitution metal element M including at least one selected from transition metal elements and typical metal elements except for Mn.

15. The rechargeable lithium battery according to claim 14, wherein the positive electrode material has the deficient quantity x set in a range of: 0.03<x≦0.5 and the substitution quantity y set in a range of: 0.03<y≦0.5.

16. The rechargeable lithium battery according to claim 15, wherein the positive electrode material has the substitution metal element M being at least one selected from the group consisting of Co, Ni, Fe, Al, Ga, In, V, Nb, Ta, Ti, Zr and Ce.

17. The rechargeable lithium battery according to claim 15, wherein the positive electrode material has the substitution metal element M including at least Cr.

18. The rechargeable lithium battery according to claim 15, wherein the positive electrode material has the deficient quantity x set in a range of: 0.1<x<0.33.
